(19) United States
(12) Patent Application Publication
(10) Pub. No.: US 2026/0017559 A1
(43) Pub. Date: Jan. 15, 2026

(54) SYSTEMS AND METHODS FOR REGULARIZING TIME-SERIES DATA

(71) Applicant: Capital One Services, LLC, McLean, VA (US)

(72) Inventors: Justin ESSERT, Richmond, VA (US); Vannia GONZALEZ MACIAS, Glen Allen, VA (US); Pratik GANDHI, McLean, VA (US)

(73) Assignee: Capital One Services, LLC, McLean, VA (US)

(21) Appl. No.: 18/771,645

(22) Filed: Jul. 12, 2024

(51) Int. Cl. G06N 20/00

(52) U.S. Cl. CPC G06N 20/00

(57) ABSTRACT

Systems and methods for regularizing time-series data for training artificial intelligence models. The system receives a time-series dataset and an objective vector, including a temporal parameter and an interpolation parameter. The system identifies the timestep based on the time-series dataset and the temporal parameter. Based on the timestep, the system determines a start time of the time-series dataset. Based on the start time of the time-series dataset, the system identifies a set of timestamps and a set of values based on the interpolation parameter, each value corresponding to a timestamp. The system generates a modified time-series dataset by modifying the time-series dataset to include the set of timestamps and the set of values. The system then determines excess data in the time-series dataset and removes the excess data to generate the processed dataset. The system uses the processed dataset as training data to train a first machine learning model.

### BACKGROUND

Time series data is a series of data organized by points in time. A time-series dataset containing such data faces challenges such as missing values, duplicate entries, inconsistencies in value types, inconsistencies in time values, inaccurate values, lack of data standards, etc. When processing time-series data, conventional approaches use ad-hoc selections of appropriate techniques that appear suitable to the particular time-series data being processed at the moment, with little to no adherence to standard procedure or a reasoned framework for choices in the processing of time-series data.

### SUMMARY

Systems and methods described herein relate to standardizing the regularization of time-series data. Current systems for processing time-series data make arbitrary choices regarding granularity, mandated start times, and processing of null values, resulting in inconsistent data that perform poorly when used to, for example, train machine learning models. This technical problem is challenging due to a lack of standard procedure that maintains flexibility in the face of the distinctive needs of each time-series data.

The systems and methods described here address this challenge with a unified framework and process for regularizing time-series data. The system identifies a uniform timestep between consecutive entries in the time-series data, ensuring the consistency of the resulting regularized dataset. Additionally, the system uses an objective vector specifying the needs of the regularization to generate values for missing data, ensuring the high quality of data. This stands in contrast to conventional methods of processing missing data and null values, where a lack of guidelines causes time-series data to often lack entries or retain low-quality data. The procedures of the systems and methods described are replicable across multiple time-series datasets, and therefore create a standardized data structure leading to more efficient comparison and effective uses of the time-series data.

The systems and methods described here have the additional advantage of determining values for null and missing values with the aid of excess data. The system uses interpolation based on an abundance of data in the comprehensive modified dataset before removing excess data to generate the final processed dataset. This results in better-informed calculations for missing values and retains more high-quality information than discarding excess data. Therefore, the procedures of the systems and methods described here results in better-quality data consistently.

In some aspects, systems and methods are described herein comprising: receiving a time-series dataset and an objective vector, wherein the objective vector comprises a temporal parameter and an interpolation parameter for generating a processed dataset resulting from aggregation of a plurality of entries from the time-series dataset, and wherein the temporal parameter imposes a limit on a timestep of the processed dataset; identifying the timestep based on the time-series dataset and the temporal parameter, wherein the timestep is a real-valued interval of time; based on the timestep, determining a start time of the time-series dataset; based on the start time of the time-series dataset, identifying a set of timestamps; determining a set of values based on the interpolation parameter, each value in the set of values corresponding to a timestamp in the set of timestamps; generating a modified time-series dataset by modifying the time-series dataset to include the set of timestamps and the set of values; based on the modified time-series dataset, determining excess data in the time-series dataset; removing excess data from the modified time-series dataset to generate the processed dataset, wherein any two sequential entries in the processed dataset is separated by the timestep; and using the processed dataset as training data, training a first machine learning model.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for regularizing time-series data for training artificial intelligence models, in accordance with one or more embodiments.

FIG. 2A shows an illustration of a time-series dataset being processed to generate a processed dataset, in accordance with one or more embodiments.

FIG. 2B shows an illustration of timestep selection for a time-series dataset, in accordance with one or more embodiments.

FIG. 2C shows an illustration of various value computation methods, in accordance with one or more embodiments.

FIG. 3 shows illustrative components for a system for regularizing time-series data for training artificial intelligence models, in accordance with one or more embodiments.

FIG. 4 shows a flowchart of the steps involved in regularizing time-series data for training artificial intelligence models, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

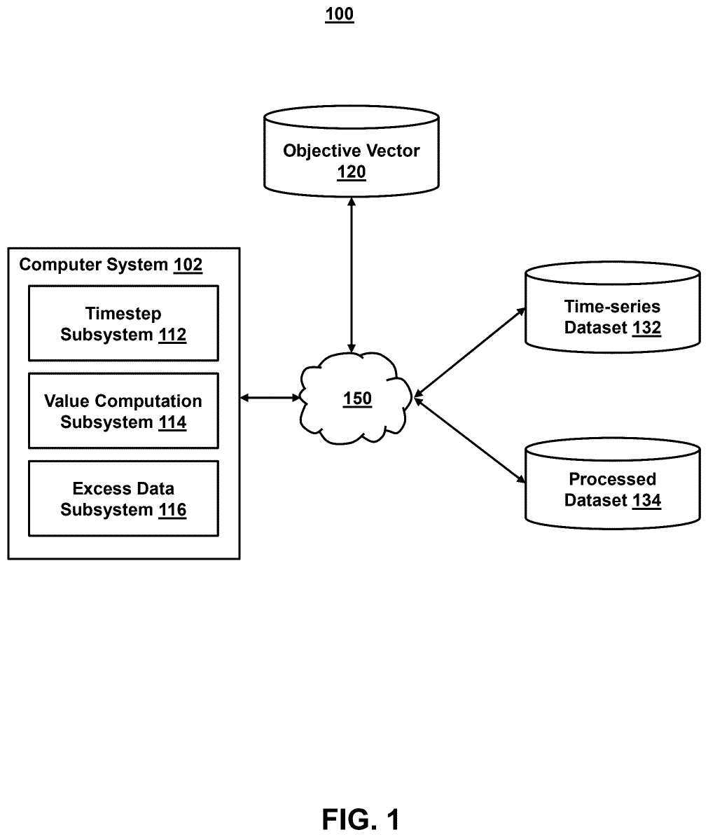

FIG. 1 shows an illustrative diagram 100 for system 150, which contains hardware and software components used for detecting anomalous data updates, in accordance with one or more embodiments. For example, system 150 may identify a uniform timestep between consecutive entries in the time-series data, ensuring the consistency of the resulting regularized dataset (e.g., Processed Dataset 134). The system may use an objective vector (e.g., Objective Vector 120) specifying the needs of the regularization to generate values for missing data, ensuring the high quality of data.

For example, Computer System 102, a part of system 150, may include Timestep Subsystem 112, Value Computation Subsystem 114, and Excess Subsystem 116. Additionally, system 150 may create, retrieve, store, or use Objective Vector 120, Time-series Dataset 132, and Processed Dataset 134 in one or more contexts.

The system (e.g., system 150) may receive a time-series dataset (e.g., Time-series Dataset 132). Time-series data is defined by its entries each containing a time value. Time-series data may contain a set of features, containing categorical or quantitative variables. Each entry may correspond to values for the set of features, and in particular, have a time value. Time-series Dataset 132 may contain a plurality of missing values. For example, one or more entries may have missing values, incorrect values or values of the wrong type in one or more features. Additionally, entries in Time-series Dataset 132 may be poorly organized. For example, the formats may differ between entries, some entries may contain extraneous features, and the time values may be inconsistent between entries. In some embodiments, Time-series Dataset 132 is generated by aggregating strands of time-series data from various sources. The time-series data may be collected by multiple entities using a myriad of techniques, resulting in the inconsistencies and the missing values of Time-series Dataset 132. For example, Time-series Dataset 132 contains features describing a user system's make and model, the user system's location, the membership of the user system in any networks, any allocations of resources to the user system, a length of time for which the user system has recorded resource consumption, an extent and frequency of resource consumption, and the number of instances of the user system's excessive resource consumption. Various entries in Time-series Dataset 132 may lack values for one or more of the full set of features, or have values recorded in a different format due to incompatible data collection protocols. Additionally, Time-series Dataset 132 may contain duplicate data due to data being collected more than once from a plurality of sources.

Concurrently or subsequently to receiving or generating Time-series Dataset 132, the system may retrieve an objective vector (e.g., Objective Vector 120). Objective Vector 120 specifies goals for the regularization of Time-series Dataset 132 into a processed dataset (e.g., Processed Dataset 134). For example, the regularization may aim to achieve a consistent timestep between consecutive entries in Processed Dataset 134, as opposed to the fluctuating time separations of Time-series Dataset 132. For example, Objective Vector 120 may describe goals for Processed Dataset 134, such as a specific value for a timestep, a maximum value for a time step, a defined start time, a latest start time, a default value for null values of entries, or a value computation method for values in the processed dataset. Objective Vector 120 may be used to determine, for example, a set of timestamps starting with a start time, and incrementally progressing in time to define the entries for the processed dataset. Each entry in Processed Dataset 134, for example, may be separated from its preceding and following entries by exactly the same timestep. In some embodiments, Objective Vector 120 may contain a temporal parameter and/or an interpolation parameter. The temporal parameter may, for example, specify a start time, an end time, a timestep between all consecutive entries, or a set of timestamps for Processed Dataset 134. The interpolation parameter may specify, for example, a method of computation for a value marked as missing or unknown in Processed Dataset 134.

The system, for example using Timestep Subsystem 112, may determine a timestep for Processed Dataset 134. For example, the timestep is a real value indicating a length of time, and any entry in Processed Dataset 134 should be separated from its immediately preceding entry and its immediately following entry by exactly a timestep. The system may identify the timestep using Time-series Dataset 132 and Objective Vector 120. For example, the system may compute a frequency of occurrence for each potential timestep in Time-series Dataset 132. Each potential timestep is the difference in time value between an entry and the closest other entry. Some potential timesteps occur with greater frequency than other potential timesteps, and Timestep Subsystem 112 may select the most frequently occurring potential timestep to be the timestep. For example, many entries in Time-series Dataset 132 may be separated by a day from the next entry, while some other entries in Time-series Dataset 132 are separated by a few days from the next entry. Timestep Subsystem 112 may, in this case, select one day to be the timestep for generating Processed Dataset 134. In some embodiments, the system may compare the most common timestep in Time-series Dataset 132 to a temporal parameter in Objective Vector 120 to set a timestep for Processed Dataset 134. For example, Objective Vector 120 may contain a temporal parameter specifying a maximum timestep. In this example, Timestep Subsystem 112 may select the common timestep in Time-series Dataset 132 to be the timestep only if it does not exceed the maximum timestep; otherwise Timestep Subsystem 112 may use the maximum timestep of Objective Vector 120. In another example, Objective Vector 120 may simply specify a desired timestep, which Timestep Subsystem 112 will adopt as the timestep to be used in Processed Dataset 134.

The system, concurrently or after determining the timestep, may determine a start time for Processed Dataset 134. For example, the system may scan Time-series Dataset 132 and find the entry with the earliest time value. The system may then compare this against a temporal parameter, such as a latest start time, specified in Objective Vector 120. In some embodiments, the system may set the start time to be the earlier of the earliest time value in Time-series Dataset 132 and the temporal parameter. In some other embodiments, the system may set the start time to the temporal parameter regardless of the earliest time value in Time-series Dataset 132. Using the start time, the system may then determine a set of timestamps. Starting at the start time, the system may iteratively add a timestep to the previous timestamp to obtain the time value for the next timestamp. For example, the first timestamp in the set of timestamps is the start time. The second timestamp is precisely one timestep after the timestamp, the third timestamp is one timestep after the second timestamp and two timesteps after the start time. The system may add the set of timestamps as entries to Time-series Dataset 132. The entries corresponding to the set of timestamps may contain no values for other features, as they serve to indicate that Processed Dataset 134, when generated in full, is to have these timestamps. The set of timestamps, due to their being separated by a constant time period, introduce uniformity and consistency into Processed Dataset 134.

Value Computation Subsystem 114 may identify a set of entries in Time-series Dataset 132 that miss one or more values. This may be, for example, the consequence of adding the set of timestamps to Time-series Dataset 132 without corresponding values for other features being immediately available. Aside from the set of timestamps, Time-series Dataset 132 may contain entries that have missing values, null values, values of an incorrect type, or otherwise disqualified values in one or more features. Value Computation Subsystem 114 may determine to compute values for these entries, the value computation method being based on Objective Vector 120. For each timestamp in the set of timestamps, Value Computation Subsystem 114 may determine corresponding values for each feature in the set of features in Time-series Dataset 132. For entries lacking values in one or more features, Value Computation Subsystem 114 may use a value computation method, for example as described by the interpolation parameter of Objective Vector 120. For example, Objective Vector 120 may contain an interpolation parameter specifying a forward-fill algorithm. Value Computation Subsystem 114 may thus choose to fill each missing value by searching for the value in the same feature for the entry immediately preceding the missing value in Time-series Dataset 132. For example, if the entry for June 4^{th} is missing a value for the “resource consumption amount” feature in Time-series Dataset 132, Value Computation Subsystem 114 may find the immediately preceding entry in Time-series Dataset 132, which may be June 3^{rd}. Value Computation Subsystem 114 may fill in the resource consumption amount for June 4^{th} to be the same value as June 3^{rd}.

In another example, Objective Vector 120 may contain an interpolation parameter specifying a backward-fill algorithm. Value Computation Subsystem 114 may therefore find the immediately following entry for any missing value, and use the corresponding value to fill the missing value. If the entry for June 4^{th} is missing a value for the “resource consumption amount” feature in Time-series Dataset 132, Value Computation Subsystem 114 may find the immediately following entry, e.g., June 5^{th}, and use its value for resource consumption amount. In the case that June 5^{th} also has a null value for this feature, Value Computation Subsystem 114 may back-propagate through Time-series Dataset 132 and scan immediately following entries until an entry with a non-null value for the feature has been found.

In another example, Objective Vector 120 may contain an interpolation parameter specifying a linear interpolation algorithm. For each missing value, Value Computation Subsystem 114 may therefore locate a first value in the time-series dataset from an entry immediately preceding the missing value with a non-null value. Value Computation Subsystem 114 may locate a second value in the time-series dataset from an entry immediately following the missing value with a non-null value. Value Computation Subsystem 114 may fill the missing value with the mathematical average of the first value and the second value.

In another example, Objective Vector 120 may contain an interpolation parameter specifying a time-weighted interpolation algorithm. For each missing value, Value Computation Subsystem 114 may therefore locate a first value in the time-series dataset from an entry immediately preceding the missing value with a non-null value. Value Computation Subsystem 114 may locate a second value in the time-series dataset from an entry immediately following the missing value with a non-null value. Value Computation Subsystem 114 may fill the missing value with a weighted average of the first value and the second value. The weighted average may be based on the separation in time from the time value of the missing value to the time value of the first value, and a similar separation between the time value of the missing value to the time value of the second value. For example, if the first value is 5 days before the missing value, but the second value is 2 days after the missing value, Value Computation Subsystem 114 may calculate the missing value to be a weighted average with 29% of the first value and 71% of the second value.

In another example, Objective Vector 120 may contain an interpolation parameter specifying a similarity-based interpolation algorithm. In this example, Value Computation Subsystem 114 may use a similarity machine learning model to generate a similarity metric between the timestamp and each entry in the time-series dataset. The similarity machine learning model may take as input, for example, features of the time-series dataset and output a numerical score indicating a level of similarity between two entries in Time-series Dataset 132. For each null value, Value Computation Subsystem 114 selects an entry with the highest similarity score, and replaces the null value with the corresponding feature value in the similar entry.

Value Computation Subsystem 114 may modify Time-series Dataset 132 using the set of values to generate a modified dataset. The modified dataset contains all of Time-series Dataset 132, with the addition of the set of timestamps. Additionally, Value Computation Subsystem 114 has filled all null values in the modified dataset, including for the set of timestamps. Therefore, the modified dataset is a fully populated time-series dataset containing the full set of features, with entries at the set of timestamps as well as entries originally in Time-series Dataset 132.

The modified dataset contains the set of timestamps as well as original entries in Time-series Dataset 132. Excess Data Subsystem 116 may determine some of the entries in the modified dataset to be excessive. For example, some data is repetitive with each other in the modified dataset. Additionally, some entries have incurable quality issues that make them unsuitable for use. Excess Data Subsystem 116 may therefore choose to remove excess data from the modified dataset. In some embodiments, excess data may be identified as missing more than one value in the modified dataset. Such data is difficult to interpolate values for, and if used causes dilution of good-quality data. In some other embodiments, Excess Data Subsystem 116 may identify entries in the modified dataset whose time value is not in the set of timestamps. By removing all entries not in the set of timestamps, Excess Data Subsystem 116 ensures complete consistency between adjacent entries in Processed Dataset 134. In some embodiments, Excess Data Subsystem 116 may use a combined approach. For example, Excess Data Subsystem 116 may first exempt entries corresponding to the set of timestamps from being excess data. Then, Excess Data Subsystem 116 may determine a proportion or a number of entries with the lowest quality to be excess data. The lowest quality data may be defined as missing the largest number of entries. Alternatively, the lowest quality data may be defined as entries missing values in key features.

Excess Data Subsystem 116 may remove excess data from the modified dataset to generate Processed Dataset 134. For example, Excess Data Subsystem 116 may label entries that it determines to be excess data with a flag parameter, the flag parameter indicating that it is to be removed. Excess Data Subsystem 116 may then use Objective Vector 120 to determine modifications to excess data. For example, Objective Vector 120 may specify certain entries to be excess data, or that some entries are not to be removed regardless. Excess Data Subsystem 116 may then modify the flag parameter values for the entries specified in Objective Vector 120. Then, Excess Data Subsystem 116 may clean the modified dataset by removing all entries with a flag parameter value of true.

The resulting Processed Dataset 134, after removing excess data from the modified dataset, has a consistent timestep between entries, contains few if any missing or null values, and has consistent types across features for all entries. For example, Processed Dataset 134 contains entries that are spaced by exactly one timestep, creating consistency in time lag between entries. The consistency is conducive to easier extrapolation and makes for good training data for machine learning models. For example, Processed Dataset 134 has values computed according to Objective Vector 120, leading to convincing values where the entry would have had a missing value. In addition, Processed Dataset 134 maintains the same types and formats for each feature across all entries, leading to less disruptions when using the data to forecast. Processed Dataset 134, being a high-quality, consistent time-series dataset, can be used for training machine learning models, generating time-series projections, and other purposes with reliable results.

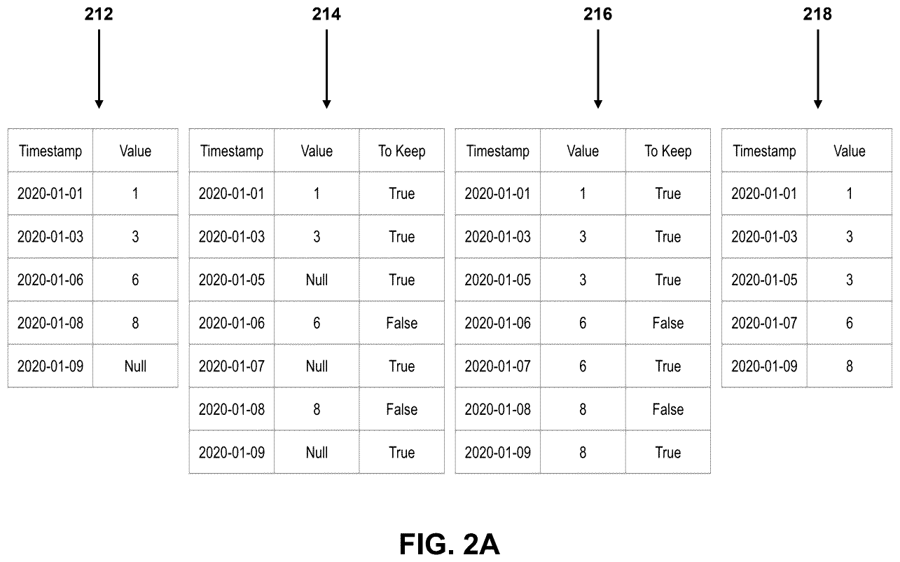

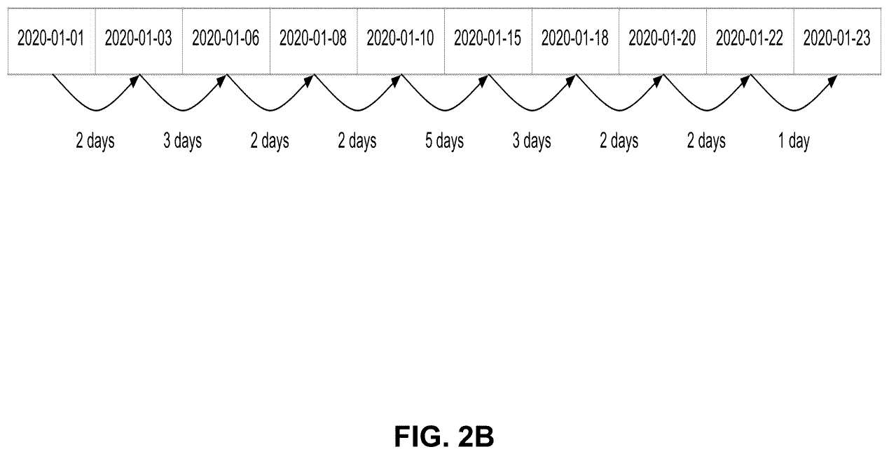

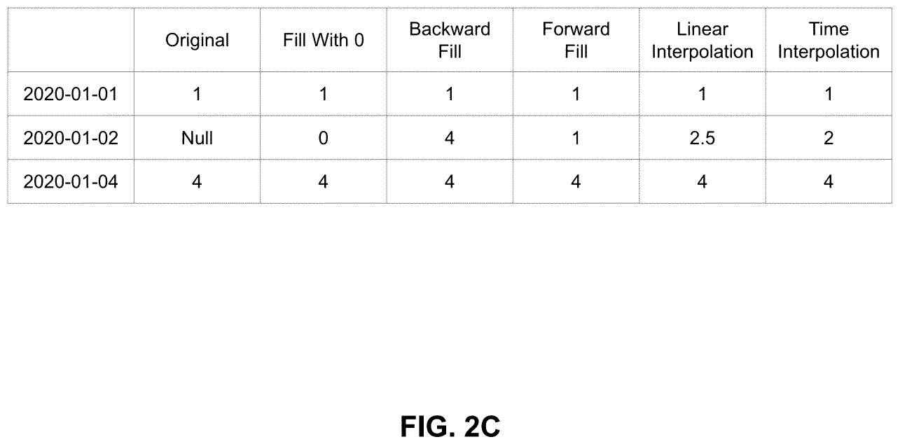

FIG. 2A is a demonstration of an example Time-series Dataset 132 being processed to generate a Processed Dataset 134. Dataset 212 is an example dataset consisting of entries, each with a timestamp and a value. It is analogous to a Time-series Dataset 132, with irregular separations of time between entries, and containing a null value. Timestep Subsystem 112 may process Dataset 212 to generate Dataset 214, which contains a set of timestamps in addition to the ones in Dataset 212. More specifically, Timestep Subsystem 112 has selected a timestep of two days based on frequency of occurrence in Dataset 212. Using the start time of January 1^{st} and the timestep, Timestep Subsystem 112 has determined the set of timestamps to be January 1^{st}, January 3^{rd}, January 5^{th}, January 7^{th}, and January 9^{th}. The set of timestamps are added to Dataset 212 to result in Dataset 214. In Dataset 214, some entries have missing values due to being added from the set of timestamps and having no corresponding value in 212. In addition, entries may have a “to keep” value indicating whether the entry is excess data. For example, the set of timestamps all have a true value for “to keep” since the system intends for the resulting processed dataset to contain all entries in the set of timestamps. Some entries in Dataset 214 are holdovers from Dataset 212 and therefore have a false “to keep” value, indicating that they are excess data. But before removing the excess data from the dataset, the system first generates a Dataset 216 by filling null values in Dataset 214. The system may use Value Computation Subsystem 114 in combination with an interpolation parameter of Objective Vector 120 to calculate values for the entries of January 5^{th}, January 7^{th} and January 9^{th}. Notice that for Dataset 216, entries like January 6^{th} and January 8^{th} are still included. This gives more complete data which better informs appropriate values for the entries with null values. For example, January 5^{th} may derive its value from January 3^{rd}, January 7^{th} from January 6^{th}, and January 9^{th} from January 8^{th}. By keeping the excess data, the system provides accurate guidance to entries in the set of timestamps, resulting in a more informed and reliable processed dataset. After filling in null values, the system may remove the excess data from Dataset 216 to generate 218, which is an example processed dataset of the same type as Processed Dataset 134 described above.

FIG. 2B demonstrates a set of entries in an example Time-series Dataset 132. Specifically, the time value for each entry is listed as a date. The entries include days in January, including the 1^{st}, 3^{rd}, 6^{th}, 8^{th}, 10^{th}, 15^{th}, 18^{th}, 20^{th}, 22^{nd}, and 23^{rd}. The separation from one entry to the next, which may be used as potential timesteps, varies in this example dataset. For example, the potential timesteps include 1 day, 2 days, 3 days, and 5 days, all of which appear as separations between two entries in Time-series Dataset 132. However, a two-day separation occurs most frequently, five times in total. The system (e.g., Timestep Subsystem 112) may thus select two days to be the potential timestep in view of requirements from Objective Vector 120. If Objective Vector 120 contains a temporal parameter that specifies, for example, a maximum timestep of one day, Timestep Subsystem 112 may select a timestep of one day despite two days being more common.

FIG. 2C demonstrates some example value-filling methods. An Objective Vector 120 may, for example, specify one of the value-filling methods shown here with an interpolation parameter. For each timestamp and its corresponding feature value, Value Computation Subsystem 114 may choose to modify the feature value if the feature value is deemed to be low-quality, for example if it is missing, null, or entered in an incorrect type. In FIG. 2C, the entries for January 1^{st} and January 4^{th} both contain values in Time-series Dataset 132, as shown by the “Original” column. Value Computation Subsystem 114 may therefore choose to preserve the feature value for these entries. However, the entry for January 2^{nd} is missing its value. Value Computation Subsystem 114 may choose to compute a value to fill this timestamp, based on the interpolation parameter of Objective Vector 120. If the interpolation parameter specifies a static fill method, Value Computation Subsystem 114 may replace this null value with a predetermined real number, for example zero. Value Computation Subsystem 114 may do the same for all other null values. If the interpolation parameter specifies a backward fill method, Value Computation Subsystem 114 may choose the value of January 4^{th} to replace the value of January 2^{nd}, thus filling it with 4. If the interpolation parameter specifies a forward fill method, Value Computation Subsystem 114 may choose the value of January 1^{st} to replace the value of January 2^{nd}, thus filling it with 1. If the interpolation parameter specifies a linear interpolation method, Value Computation Subsystem 114 may choose an unweighted mathematical average between the values for January 1^{st} and January 4^{th} for January 2^{nd}. That value would be 2.5, the average between 1 and 4. If the interpolation parameter specifies a time interpolation method, Value Computation Subsystem 114 may use a time-weighted average between the values for January 1^{st} and January 4^{th} for January 2^{nd}. That value would derive two-thirds from that of January 1^{st} and one-third from that of January 4^{th}, due to the distance in time being one day for the former value and two days for the latter value. The computation results in January 2^{nd} being assigned 2 as its value. Value Computation Subsystem 114 may perform a similar process, based on Objective Vector 120, to fill all null or missing values within Time-series Dataset 132 to generate a modified dataset.

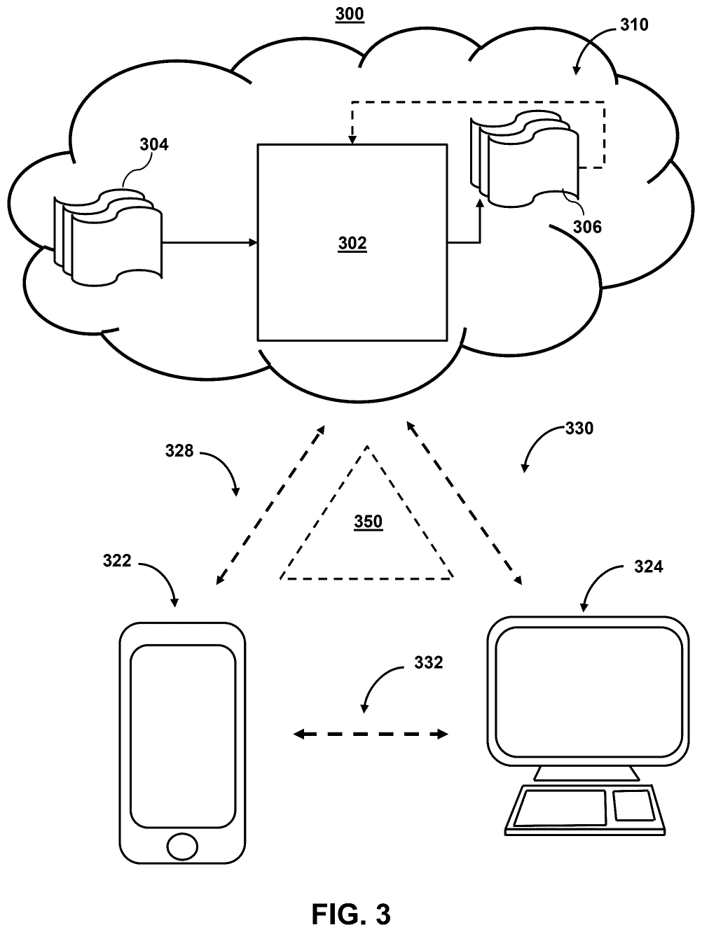

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., predicting resource allocation values for user systems).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., predicting resource allocation values for user systems).

In some embodiments, the model (e.g., model 302) may automatically perform actions based on outputs 306. In some embodiments, the model (e.g., model 302) may not perform any actions. The output of the model (e.g., model 302) may be used to predict predicting resource allocation values for user systems).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDOS protection, and API layer 350 may use RESTful APIs as standard for external integration.

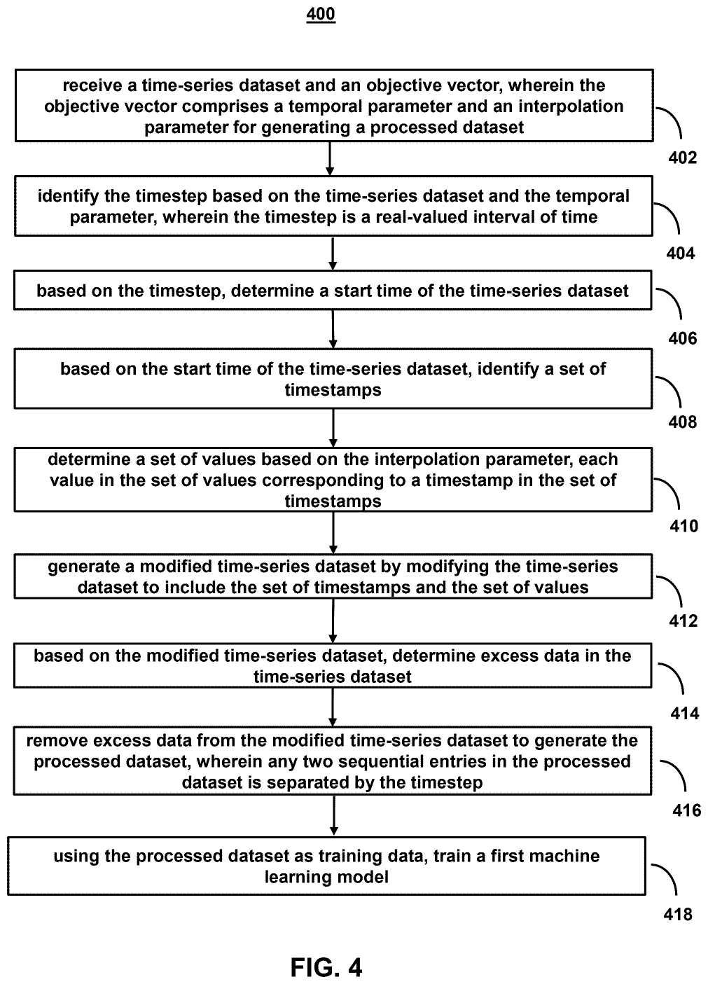

FIG. 4 shows a flowchart of the steps involved in forecasting data drift for model monitoring, in accordance with one or more embodiments. For example, the system may use process 400 (e.g., as implemented on one or more system components described above) in order to train models, create synthetic data, extract explainability vectors, and detect data drift for comparison.

At step 402, process 400 (e.g., using one or more components described above) may receive a time-series dataset and an objective vector, where the objective vector comprises a temporal parameter and an interpolation parameter for generating a processed dataset. Time-series data is defined by its entries each containing a time value. Time-series data may contain a set of features, containing categorical or quantitative variables. Each entry may correspond to values for the set of features, and in particular, have a time value. Time-series Dataset 132 may contain a plurality of missing values. For example, one or more entries may have missing values, incorrect values or values of the wrong type in one or more features. Additionally, entries in Time-series Dataset 132 may be poorly organized. For example, the formats may differ between entries, some entries may contain extraneous features, and the time values may be inconsistent between entries. In some embodiments, Time-series Dataset 132 is generated by aggregating strands of time-series data from various sources. The time-series data may be collected by multiple entities using a myriad of techniques, resulting in the inconsistencies and the missing values of Time-series Dataset 132. For example, Time-series Dataset 132 contains features describing a user system's make and model, the user system's location, the membership of the user system in any networks, any allocations of resources to the user system, a length of time for which the user system has recorded resource consumption, an extent and frequency of resource consumption, and the number of instances of the user system's excessive resource consumption. Various entries in Time-series Dataset 132 may lack values for one or more of the full set of features, or have values recorded in a different format due to incompatible data collection protocols. Additionally, Time-series Dataset 132 may contain duplicate data due to data being collected more than once from a plurality of sources.

Concurrently or subsequently to receiving or generating Time-series Dataset 132, the system may retrieve an objective vector (e.g., Objective Vector 120). Objective Vector 120 specifies goals for the regularization of Time-series Dataset 132 into a processed dataset (e.g., Processed Dataset 134). For example, the regularization may aim to achieve a consistent timestep between consecutive entries in Processed Dataset 134, as opposed to the fluctuating time separations of Time-series Dataset 132. For example, Objective Vector 120 may describe goals for Processed Data 134, such as a specific value for a timestep, a maximum value for a time step, a defined start time, a latest start time, a default value for null values of entries, or a value computation method for values in the processed dataset. Objective Vector 120 may be used to determine, for example, a set of timestamps starting with a start time, and incrementally progressing in time to define the entries for the processed dataset. Each entry in Processed Dataset 134, for example, may be separated from its preceding and following entries by exactly the same timestep. In some embodiments, Objective Vector 120 may contain a temporal parameter and/or an interpolation parameter. The temporal parameter may, for example, specify a start time, an end time, a timestep between all consecutive entries, or a set of timestamps for Processed Dataset 134. The interpolation parameter may specify, for example, a method of computation for a value marked as missing or unknown in Processed Dataset 134.

At step 404, process 400 (e.g., using one or more components described above) may identify the timestep based on the time-series dataset and the temporal parameter, wherein the timestep is a real-valued interval of time. The system, for example using Timestep Subsystem 112, may determine a timestep for Processed Dataset 134. For example, the timestep is a real value indicating a length of time, and any entry in Processed Dataset 134 should be separated from its immediately preceding entry and its immediately following entry by exactly a timestep. The system may identify the timestep using Time-series Dataset 132 and Objective Vector 120. For example, the system may compute a frequency of occurrence for each potential timestep in Time-series Dataset 132. Each potential timestep is the difference in time value between an entry and the closest other entry. Some potential timesteps occur with greater frequency than other potential timesteps, and Timestep Subsystem 112 may select the most frequently occurring potential timestep to be the timestep. For example, many entries in Time-series Dataset 132 may be separated by a day from the next entry, while some other entries in Time-series Dataset 132 are separated by a few days from the next entry. Timestep Subsystem 112 may, in this case, select one day to be the timestep for generating Processed Dataset 134. In some embodiments, the system may compare the most common timestep in Time-series Dataset 132 to a temporal parameter in Objective Vector 120 to set a timestep for Processed Dataset 134. For example, Objective Vector 120 may contain a temporal parameter specifying a maximum timestep. In this example, Timestep Subsystem 112 may select the common timestep in Time-series Dataset 132 to be the timestep only if it does not exceed the maximum timestep; otherwise Timestep Subsystem 112 may use the maximum timestep of Objective Vector 120. In another example, Objective Vector 120 may simply specify a desired timestep, which Timestep Subsystem 112 will adopt as the timestep to be used in Processed Dataset 134.

At step 406, process 400 (e.g., using one or more components described above) may, based on the timestep, determine a start time of the time-series dataset. The system, concurrently or after determining the timestep, may determine a start time for Processed Dataset 134. For example, the system may scan Time-series Dataset 132 and find the entry with the earliest time value. The system may then compare this against a temporal parameter, such as a latest start time, specified in Objective Vector 120. In some embodiments, the system may set the start time to be the earlier of the earliest time value in Time-series Dataset 132 and the temporal parameter. In some other embodiments, the system may set the start time to the temporal parameter regardless of the earliest time value in Time-series Dataset 132.

At step 408, process 400 (e.g., using one or more components described above) may, based on the start time of the time-series dataset, identify a set of timestamps. Using the start time, the system may then determine a set of timestamps. Starting at the start time, the system may iteratively add a timestep to the previous timestamp to obtain the time value for the next timestamp. For example, the first timestamp in the set of timestamps is the start time. The second timestamp is precisely one timestep after the timestamp, the third timestamp is one timestep after the second timestamp and two timesteps after the start time. The system may add the set of timestamps as entries to Time-series Dataset 132. The entries corresponding to the set of timestamps may contain no values for other features, as they serve to indicate that Processed Dataset 134, when generated in full, is to have these timestamps. The set of timestamps, due to their being separated by a constant time period, introduce uniformity and consistency into Processed Dataset 134.

At step 410, process 400 (e.g., using one or more components described above) may determine a set of values based on the interpolation parameter, each value in the set of values corresponding to a timestamp in the set of timestamps. Value Computation Subsystem 114 may identify a set of entries in Time-series Dataset 132 that miss one or more values. This may be, for example, the consequence of adding the set of timestamps to Time-series Dataset 132 without corresponding values for other features being immediately available. Aside from the set of timestamps, Time-series Dataset 132 may contain entries that have missing values, null values, values of an incorrect type, or otherwise disqualified values in one or more features. Value Computation Subsystem 114 may determine to compute values for these entries, the value computation method being based on Objective Vector 120. For each timestamp in the set of timestamps, Value Computation Subsystem 114 may determine corresponding values for each feature in the set of features in Time-series Dataset 132. For entries lacking values in one or more features, Value Computation Subsystem 114 may use a value computation method, for example as described by the interpolation parameter of Objective Vector 120. For example, Objective Vector 120 may contain an interpolation parameter specifying a forward-fill algorithm. Value Computation Subsystem 114 may thus choose to fill each missing value by searching for the value in the same feature for the entry immediately preceding the missing value in Time-series Dataset 132. For example, if the entry for June 4^{th} is missing a value for the “resource consumption amount” feature in Time-series Dataset 132, Value Computation Subsystem 114 may find the immediately preceding entry in Time-series Dataset 132, which may be June 3^{rd}. Value Computation Subsystem 114 may fill in the resource consumption amount for June 4^{th} to be the same value as June 3^{rd}.

In another example, Objective Vector 120 may contain an interpolation parameter specifying a backward-fill algorithm. Value Computation Subsystem 114 may therefore find the immediately following entry for any missing value, and use the corresponding value to fill the missing value. If the entry for June 4^{th} is missing a value for the “resource consumption amount” feature in Time-series Dataset 132, Value Computation Subsystem 114 may find the immediately following entry, e.g., June 5^{th}, and use its value for resource consumption amount. In the case that June 5^{th} also has a null value for this feature, Value Computation Subsystem 114 may back-propagate through Time-series Dataset 132 and scan immediately following entries until an entry with a non-null value for the feature has been found.

In another example, Objective Vector 120 may contain an interpolation parameter specifying a linear interpolation algorithm. For each missing value, Value Computation Subsystem 114 may therefore locate a first value in the time-series dataset from an entry immediately preceding the missing value with a non-null value. Value Computation Subsystem 114 may locate a second value in the time-series dataset from an entry immediately following the missing value with a non-null value. Value Computation Subsystem 114 may fill the missing value with the mathematical average of the first value and the second value.

In another example, Objective Vector 120 may contain an interpolation parameter specifying a time-weighted interpolation algorithm. For each missing value, Value Computation Subsystem 114 may therefore locate a first value in the time-series dataset from an entry immediately preceding the missing value with a non-null value. Value Computation Subsystem 114 may locate a second value in the time-series dataset from an entry immediately following the missing value with a non-null value. Value Computation Subsystem 114 may fill the missing value with a weighted average of the first value and the second value. The weighted average may be based on the separation in time from the time value of the missing value to the time value of the first value, and a similar separation between the time value of the missing value to the time value of the second value. For example, if the first value is 5 days before the missing value, but the second value is 2 days after the missing value, Value Computation Subsystem 114 may calculate the missing value to be a weighted average with 29% of the first value and 71% of the second value.

In another example, Objective Vector 120 may contain an interpolation parameter specifying a similarity-based interpolation algorithm. In this example, Value Computation Subsystem 114 may use a similarity machine learning model to generate a similarity metric between the timestamp and each entry in the time-series dataset. The similarity machine learning model may take as input, for example, features of the time-series dataset and output a numerical score indicating a level of similarity between two entries in Time-series Dataset 132. For each null value, Value Computation Subsystem 114 selects an entry with the highest similarity score, and replaces the null value with the corresponding feature value in the similar entry.

At step 412, process 400 (e.g., using one or more components described above) may generate a modified time-series dataset by modifying the time-series dataset to include the set of timestamps and the set of values. Value Computation Subsystem 114 may modify Time-series Dataset 132 using the set of values to generate a modified dataset. The modified dataset contains all of Time-series Dataset 132, with the addition of the set of timestamps. Additionally, Value Computation Subsystem 114 has filled all null values in the modified dataset, including for the set of timestamps. Therefore, the modified dataset is a fully populated time-series dataset containing the full set of features, with entries at the set of timestamps as well as entries originally in Time-series Dataset 132.

At step 414, process 400 (e.g., using one or more components described above) may, based on the modified time-series dataset, determine excess data in the time-series dataset. The modified dataset contains the set of timestamps as well as original entries in Time-series Dataset 132. Excess Data Subsystem 116 may determine some of the entries in the modified dataset to be excessive. For example, some data is repetitive with each other in the modified dataset. Additionally, some entries have incurable quality issues that make them unsuitable for use. Excess Data Subsystem 116 may therefore choose to remove excess data from the modified dataset. In some embodiments, excess data may be identified as missing more than one value in the modified dataset. Such data is difficult to interpolate values for, and if used causes dilution of good-quality data. In some other embodiments, Excess Data Subsystem 116 may identify entries in the modified dataset whose time value is not in the set of timestamps. By removing all entries not in the set of timestamps, Excess Data Subsystem 116 ensures complete consistency between adjacent entries in Processed Dataset 134. In some embodiments, Excess Data Subsystem 116 may use a combined approach. For example, Excess Data Subsystem 116 may first exempt entries corresponding to the set of timestamps from being excess data. Then, Excess Data Subsystem 116 may determine a proportion or a number of entries with the lowest quality to be excess data. The lowest quality data may be defined as missing the largest number of entries. Alternatively, the lowest quality data may be defined as entries missing values in key features.

At step 416, process 400 (e.g., using one or more components described above) may remove excess data from the modified time-series dataset to generate the processed dataset, wherein any two sequential entries in the processed dataset is separated by the timestep. Excess Data Subsystem 116 may remove excess data from the modified dataset to generate Processed Dataset 134. For example, Excess Data Subsystem 116 may label entries that it determines to be excess data with a flag parameter, the flag parameter indicating that it is to be removed. Excess Data Subsystem 116 may then use Objective Vector 120 to determine modifications to excess data. For example, Objective Vector 120 may specify certain entries to be excess data, or that some entries are not to be removed regardless. Excess Data Subsystem 116 may then modify the flag parameter values for the entries specified in Objective Vector 120. Then, Excess Data Subsystem 116 may clean the modified dataset by removing all entries with a flag parameter value of true.

At step 418, process 400 (e.g., using one or more components described above) may, using the processed dataset as training data, train a first machine learning model. The resulting Processed Dataset 134, after removing excess data from the modified dataset, has a consistent timestep between entries, contains few if any missing or null values, and has consistent types across features for all entries. For example, Processed Dataset 134 contains entries that are spaced by exactly one timestep, creating consistency in time lag between entries. The consistency is conducive to easier extrapolation and makes for good training data for machine learning models. For example, Processed Dataset 134 has values computed according to Objective Vector 120, leading to convincing values where the entry would have had a missing value. In addition, Processed Dataset 134 maintains the same types and formats for each feature across all entries, leading to less disruptions when using the data to forecast. Processed Dataset 134, being a high-quality, consistent time-series dataset, can be used for training machine learning models, generating time-series projections, and other purposes with reliable results.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for regularizing time-series data used for training artificial intelligence models, the method comprising: receiving a time-series dataset and an objective vector wherein the objective vector comprises a temporal parameter and an interpolation parameter for generating a processed dataset resulting from aggregation of a plurality of entries from the time-series dataset, and wherein the temporal parameter imposes a limit on a timestep of the processed dataset; identifying the timestep based on the time-series dataset and the temporal parameter, wherein the timestep is a real-valued interval of time; based on the timestep, determining a start time of the time-series dataset; based on the start time of the time-series dataset, identifying a set of timestamps, wherein a value in the time-series dataset is required for each timestamp in the set of timestamps; determining a set of values based on the interpolation parameter, each value in the set of values corresponding to a timestamp in the set of timestamps; generating a modified time-series dataset by modifying the time-series dataset to include the set of timestamps and the set of values; based on the modified time-series dataset, determining excess data in the time-series dataset; removing excess data from the modified time-series dataset to generate the processed dataset, wherein any two sequential entries in the processed dataset is separated by the timestep; and using the processed dataset as training data, training a first machine learning model.

2. A method for regularizing time-series data used for training artificial intelligence models, the method comprising: receiving a time-series dataset and an objective vector, wherein the objective vector comprises a temporal parameter and an interpolation parameter for generating a processed dataset from the time-series dataset; identifying a timestep based on the time-series dataset and the temporal parameter, wherein the timestep is a real-valued interval of time; based on the timestep, determining a start time of the time-series dataset; based on the start time of the time-series dataset, identifying a set of timestamps; determining a set of values based on the interpolation parameter, each value in the set of values corresponding to a timestamp in the set of timestamps; generating a modified time-series dataset by modifying the time-series dataset to include the set of timestamps and the set of values; based on the modified time-series dataset, determining excess data in the time-series dataset; removing excess data from the modified time-series dataset to generate the processed dataset, wherein any two sequential entries in the processed dataset is separated by the timestep; and using the processed dataset as training data, training a first machine learning model.

3. The method of any of the preceding embodiments, wherein the objective vector comprises: a maximum timestep; a latest start time; a default value; and a value computation method, wherein the value computation method specifies a mathematical method for determining values in the processed dataset.

4. The method of any of the preceding embodiments, wherein identifying a timestep based on the time-series dataset comprises: determining a maximum timestep based on the objective vector; determining a common timestep based on the time-series dataset, wherein the common timestep is a time interval occurring with highest frequency between any two entries in the time-series dataset; and determining the timestep to be a smaller of the maximum timestep and the common timestep.

5. The method of any of the preceding embodiments, wherein determining the start time of the time-series dataset comprises: determining an earliest recorded time based on the time-series dataset, wherein the earliest recorded time is an entry in the time-series dataset with an associated time before all others in the time-series dataset; determining a latest start time based on the objective vector; and selecting the start time to be the earlier of the earliest recorded time and the latest start time.

6. The method of any of the preceding embodiments, wherein identifying the set of timestamps comprises: beginning at the start time, iteratively add a time step to determine a timestamp in the set of timestamps, wherein the iterative addition comprises: selecting a latest timestamp in the set of timestamps; generating a new timestamp by adding a timestep to the latest timestamp; and adding the new timestamp to the set of timestamps.

7. The method of any of the preceding embodiments, wherein determining the set of values comprises: for each timestamp in the set of timestamps without a value, assigning the timestamp the default value in the objective vector.

8. The method of any of the preceding embodiments, wherein determining the set of values comprises: determining to use a forward-fill algorithm based on the value computation method of the objective vector; for each timestamp in the set of timestamps, determining a forward-fill value, wherein the forward-fill value is the value in the time-series dataset of an entry immediately following the timestamp with a non-null value; and for each timestamp in the set of timestamps without a value, assigning the timestamp its forward-fill value.

9. The method of any of the preceding embodiments, wherein determining the set of values comprises: determining to use a backward-fill algorithm based on the value computation method of the objective vector; for each timestamp in the set of timestamps, determining a backward-fill value, wherein the backward-fill value is the value in the time-series dataset of an entry immediately preceding the timestamp with a non-null value; and for each timestamp in the set of timestamps without a value, assigning the timestamp its backward-fill value.

10. The method of any of the preceding embodiments, wherein determining the set of values comprises: determining to use a linear interpolation algorithm based on the value computation method of the objective vector; for each timestamp in the set of timestamps, determining an expected value, wherein the expected value is an average of the value in the time-series dataset of an entry immediately preceding the timestamp with a non-null value and the value in the time-series dataset of an entry immediately following the timestamp with a non-null value; and for each timestamp in the set of timestamps without a value, assigning the timestamp its expected value.

11. The method of any of the preceding embodiments, wherein determining the set of values comprises: determining to use a time-weighted interpolation algorithm based on the value computation method of the objective vector; for each timestamp in the set of timestamps, determining a time-weighted value, comprising: determining a backward value and a backward weight, wherein the backward value is the value in the time-series dataset of an entry immediately preceding the timestamp with a non-null value, and the backward weight is an inverse of the interval of time between the immediately preceding entry and the timestamp; determining a forward value and a forward weight, wherein the forward value is the value in the time-series dataset of an entry immediately following the timestamp with a non-null value, and the forward weight is an inverse of the interval of time between the immediately following entry and the timestamp; determining the time-weighted value based on a mathematical combination of the backward value and the forward value using the backward weight and the forward weight; and for each timestamp in the set of timestamps without a value, assigning the timestamp its time-weighted value.

12. The method of any of the preceding embodiments, wherein determining the set of values comprises: determining to use a similarity-based interpolation algorithm based on the value computation method of the objective vector; for each timestamp in the set of timestamps, determining a similar value, wherein the similar value is the value in the time-series dataset of an entry selected based on similarity to the timestamp; and for each timestamp in the set of timestamps without a value, assigning the timestamp its similar value.

13. The method of any of the preceding embodiments, wherein selecting an entry in the time-series dataset based on similarity to a timestamp comprises: using a similarity machine learning model, generating a similarity metric between the timestamp and each entry in the time-series dataset, wherein the similarity machine learning model takes as input features of the time-series dataset; and selecting the entry based on a highest similarity metric among all entries in the time-series dataset.

14. The method of any of the preceding embodiments, wherein determining excess data comprises: for each entry in the time-series dataset, determining the entry to be excess data in response to detecting more than one null value.

15. One or more non-transitory computer-readable media storing instructions that, when executed by a data processing apparatus, cause the data processing apparatus to perform operations comprising those of any of embodiments 1-14.

16. A system comprising one or more processors; and memory storing instructions that, when executed by the processors, cause the processors to effectuate operations comprising those of any of embodiments 1-14.

17. A system comprising means for performing any of embodiments 1-14.

What is claimed is:

1. A system for regularizing time-series data for training artificial intelligence models, the system comprising:
one or more processors; and
one or more non-transitory, computer-readable media comprising instructions that, when executed by the one or more processors, cause operations comprising:
receiving a time-series dataset and an objective vector wherein the objective vector comprises a temporal parameter and an interpolation parameter for generating a processed dataset resulting from aggregation of a plurality of entries from the time-series dataset, and wherein the temporal parameter imposes a limit on a timestep of the processed dataset;
identifying the timestep based on the time-series dataset and the temporal parameter, wherein the timestep is a real-valued interval of time;
based on the timestep, determining a start time of the time-series dataset;
based on the start time of the time-series dataset, identifying a set of timestamps, wherein a value in the time-series dataset is required for each timestamp in the set of timestamps;
determining a set of values based on the interpolation parameter, each value in the set of values corresponding to a timestamp in the set of timestamps;
generating a modified time-series dataset by modifying the time-series dataset to include the set of timestamps and the set of values;
based on the modified time-series dataset, determining excess data in the time-series dataset;
removing excess data from the modified time-series dataset to generate the processed dataset, wherein any two sequential entries in the processed dataset is separated by the timestep; and
using the processed dataset as training data, training a first machine learning model.

2. A method for regularizing time-series data used for training artificial intelligence models, the method comprising:
receiving a time-series dataset and an objective vector, wherein the objective vector comprises a temporal parameter and an interpolation parameter for generating a processed dataset resulting from aggregation of a plurality of entries from the time-series dataset, and wherein the temporal parameter imposes a limit on a timestep of the processed dataset;
identifying the timestep based on the time-series dataset and the temporal parameter, wherein the timestep is a real-valued interval of time;
based on the timestep, determining a start time of the time-series dataset;
based on the start time of the time-series dataset, identifying a set of timestamps;
determining a set of values based on the interpolation parameter, each value in the set of values corresponding to a timestamp in the set of timestamps;
generating a modified time-series dataset by modifying the time-series dataset to include the set of timestamps and the set of values;
based on the modified time-series dataset, determining excess data in the time-series dataset;
removing excess data from the modified time-series dataset to generate the processed dataset, wherein any two sequential entries in the processed dataset is separated by the timestep; and
using the processed dataset as training data, training a first machine learning model.

3. The method of claim 2, wherein the objective vector comprises:
a maximum timestep;
a latest start time;
a default value; and
a value computation method, wherein the value computation method specifies a mathematical method for determining values in the processed dataset.

4. The method of claim 2, wherein identifying a timestep based on the time-series dataset comprises:
determining a maximum timestep based on the objective vector;
determining a common timestep based on the time-series dataset, wherein the common timestep is a time interval occurring with highest frequency between any two entries in the time-series dataset; and
determining the timestep to be a smaller of the maximum timestep and the common timestep.

5. The method of claim 2, wherein determining the start time of the time-series dataset comprises:
determining an earliest recorded time based on the time-series dataset, wherein the earliest recorded time is an entry in the time-series dataset with an associated time before all others in the time-series dataset;
determining a latest start time based on the objective vector; and
selecting the start time to be the earlier of the earliest recorded time and the latest start time.

6. The method of claim 2, wherein identifying the set of timestamps comprises:
beginning at the start time, iteratively add a time step to determine a timestamp in the set of timestamps, wherein the iterative addition comprises:
selecting a latest timestamp in the set of timestamps;
generating a new timestamp by adding a timestep to the latest timestamp; and
adding the new timestamp to the set of timestamps.

7. The method of claim 3, wherein determining the set of values comprises:
for each timestamp in the set of timestamps without a value, assigning the timestamp the default value in the objective vector.

8. The method of claim 3, wherein determining the set of values comprises:
determining to use a forward-fill algorithm based on the value computation method of the objective vector;
for each timestamp in the set of timestamps, determining a forward-fill value, wherein the forward-fill value is the value in the time-series dataset of an entry immediately following the timestamp with a non-null value; and
for each timestamp in the set of timestamps without a value, assigning the timestamp its forward-fill value.

9. The method of claim 3, wherein determining the set of values comprises:
determining to use a backward-fill algorithm based on the value computation method of the objective vector;
for each timestamp in the set of timestamps, determining a backward-fill value, wherein the backward-fill value is the value in the time-series dataset of an entry immediately preceding the timestamp with a non-null value; and
for each timestamp in the set of timestamps without a value, assigning the timestamp its backward-fill value.

10. The method of claim 3, wherein determining the set of values comprises:
determining to use a linear interpolation algorithm based on the value computation method of the objective vector;
for each timestamp in the set of timestamps, determining an expected value, wherein the expected value is an average of the value in the time-series dataset of an entry immediately preceding the timestamp with a non-null value and the value in the time-series dataset of an entry immediately following the timestamp with a non-null value; and
for each timestamp in the set of timestamps without a value, assigning the timestamp its expected value.

11. The method of claim 3, wherein determining the set of values comprises:
determining to use a time-weighted interpolation algorithm based on the value computation method of the objective vector;
for each timestamp in the set of timestamps, determining a time-weighted value, comprising:
determining a backward value and a backward weight, wherein the backward value is the value in the time-series dataset of an entry immediately preceding the timestamp with a non-null value, and the backward weight is an inverse of the interval of time between the immediately preceding entry and the timestamp;
determining a forward value and a forward weight, wherein the forward value is the value in the time-series dataset of an entry immediately following the timestamp with a non-null value, and the forward weight is an inverse of the interval of time between the immediately following entry and the timestamp;
determining the time-weighted value based on a mathematical combination of the backward value and the forward value using the backward weight and the forward weight; and
for each timestamp in the set of timestamps without a value, assigning the timestamp its time-weighted value.

12. The method of claim 3, wherein determining the set of values comprises:
determining to use a similarity-based interpolation algorithm based on the value computation method of the objective vector;
for each timestamp in the set of timestamps, determining a similar value, wherein the similar value is the value in the time-series dataset of an entry selected based on similarity to the timestamp; and
for each timestamp in the set of timestamps without a value, assigning the timestamp its similar value.

13. The method of claim 12, wherein selecting an entry in the time-series dataset based on similarity to a timestamp comprises:
using a similarity machine learning model, generating a similarity metric between the timestamp and each entry in the time-series dataset, wherein the similarity machine learning model takes as input features of the time-series dataset; and
selecting the entry based on a highest similarity metric among all entries in the time-series dataset.

14. The method of claim 2, wherein determining excess data comprises:
for each entry in the time-series dataset, determining the entry to be excess data in response to detecting more than one null value.

15. One or more non-transitory computer-readable media comprising instructions that, when executed by one or more processors, cause operations comprising:
receiving a time-series dataset and an objective vector, wherein the objective vector comprises a temporal parameter and an interpolation parameter for generating a processed dataset from the time-series dataset;
identifying a timestep based on the time-series dataset and the temporal parameter, wherein the timestep is a real-valued interval of time;
based on the timestep, determining a start time of the time-series dataset;
based on the start time of the time-series dataset, identifying a set of timestamps;
determining a set of values based on the interpolation parameter, each value in the set of values corresponding to a timestamp in the set of timestamps;
generating a modified time-series dataset by modifying the time-series dataset to include the set of timestamps and the set of values;
based on the modified time-series dataset, determining excess data in the time-series dataset;
removing excess data from the modified time-series dataset to generate the processed dataset, wherein any two sequential entries in the processed dataset is separated by the timestep; and
using the processed dataset as training data, training a first machine learning model.

16. The one or more non-transitory computer-readable media of claim 15, wherein the objective vector comprises one or more of:
a maximum timestep;
a latest start time;
a default value; and
a value computation method, wherein the value computation method specifies a mathematical method for determining values in the processed dataset.

17. The one or more non-transitory computer-readable media of claim 15, wherein determining the start time of the time-series dataset comprises:
determining an earliest recorded time based on the time-series dataset, wherein the earliest recorded time is an entry in the time-series dataset with an associated time before all others in the time-series dataset;
determining a latest start time based on the objective vector; and
selecting the start time to be the earlier of the earliest recorded time and the latest start time.

18. The one or more non-transitory computer-readable media of claim 16, wherein determining the set of values comprises:
determining to use a forward-fill algorithm based on the value computation method of the objective vector;
for each timestamp in the set of timestamps, determining a forward-fill value, wherein the forward-fill value is the value in the time-series dataset of an entry immediately following the timestamp with a non-null value; and
for each timestamp in the set of timestamps without a value, assigning the timestamp its forward-fill value.

19. The one or more non-transitory computer-readable media of claim 16, wherein determining the set of values comprises:
determining to use a linear interpolation algorithm based on the value computation method of the objective vector;
for each timestamp in the set of timestamps, determining an expected value, wherein the expected value is an average of the value in the time-series dataset of an entry immediately preceding the timestamp with a non-null value and the value in the time-series dataset of an entry immediately following the timestamp with a non-null value; and
for each timestamp in the set of timestamps without a value, assigning the timestamp its expected value.

20. The one or more non-transitory computer-readable media of claim 15, wherein determining excess data comprises:
for each entry in the time-series dataset, determining the entry to be excess data in response to detecting more than one null value.
